(19) United States
(12) Patent Application Publication
(10) Pub. No.: US 2015/0172376 A1
(43) Pub. Date: Jun. 18, 2015

(54) METHOD FOR PROVIDING SOCIAL NETWORK SERVICE AND ELECTRONIC DEVICE IMPLEMENTING THE SAME

(71) Applicant: Samsung Electronics Co., Ltd., Gyeonggi-do (KR)

(72) Inventor: Jin Park, Gyeonggi-do (KR)

(21) Appl. No.: 14/574,164

(22) Filed: Dec. 17, 2014

(30) Foreign Application Priority Data
Dec. 17, 2013 (KR) 10-2013-0156844

(51) Int. Cl. H04L 29/08

(52) U.S. Cl. CPC H04L 67/10

(57) ABSTRACT

A method for providing a Social Network Service (SNS) includes extracting feature information from at least one of the inputs from a camera and a microphone. The method also includes transmitting the extracted feature information to a server. The method also includes receiving, from the server, at least one of information and a memo associated with an SNS user who matches the extracted feature information. The method also includes displaying at least one of the received information and the received memo.

### CROSS-REFERENCE TO RELATED APPLICATION(S) AND CLAIM OF PRIORITY

The present application is related to and claims priority from and the benefit under 35 U. S.C. §119(a) of Korean Patent Application No. 10-2013-0156844, filed on Dec. 17, 2013, which is hereby incorporated by reference for all purposes as if fully set forth herein.

### TECHNICAL FIELD

The present disclosure relates generally to a method for providing a Social Network Service (SNS), and an electronic device implementing the same.

### BACKGROUND

As electronic devices have developed to execute various functions, for example, capturing an image, playing back multimedia files, such as a music file, a video file, or the like, receiving/outputting broadcast signals, a navigation service, and the like, the electronic devices have been embodied as comprehensive multimedia players.

Various new attempts are applied to this type of a multimedia device from the perspective of hardware or software, so as to embody a complex function. For example, a User Interface (UI) environment that is embodied in various forms has been provided such that a user readily and conveniently searches for or selects a function.

For example, Augmented Reality (AR) is a technology that shows a virtual object augmented on the reality viewed by the eyes of a user. The augmented reality technology is embodied as a mixture of the reality that a user views and a virtual object, and provides various additional information. Games and mobile solution industries, education industries, and the like have developed various products using the same.

For example, the augmented reality may be embodied by a wearable computer. In an embodiment, a wearable computer which is worn on a head may show a computer graphic, characters, or the like, augmented on the reality that a user views. Accordingly, research on the augmented reality is mainly associated with the development of a wearable computer. An augmented reality system that has been developed includes a Head Mounted Display (HMD) such as a video type HMD, an optical type HMD, and the like.

### SUMMARY

A conventional electronic device may not connect a Social Network Service (SNS) provided online with offline (real) relationships. For example, although an online SNS relationship exist, it may be difficult to maintain the SNS relationship as an offline relationship unless the relationship is formed by a physical meeting. In other words, although the relationship with a predetermined person is established online, a user may have difficulty in identifying the predetermined person when the user actually meets the predetermined person. Also, conventionally, shared information in the SNS is not classified into an online group and an offline group. For example, there may be information that the user desires not to share in an online group but desires to share in an offline group.

To address the above-discussed deficiencies, it is a primary object to provide a method for providing an SNS using augmented reality and an electronic device implementing the same.

The electronic device recognizes a feature of a subject that is photographed by a camera or of which a voice is sensed and, in association with this, provides an SNS. Accordingly, there is provided a method for providing an SNS using the augmented reality that readily connects and extends the relationship formed online to an offline relationship, and an electronic device implementing the same.

Various embodiments provide a method for providing an SNS using augmented reality of an electronic device, and the electronic device implementing the same.

In an embodiment, a method provides a Social Network Service (SNS) using an electronic device. The method includes extracting feature information from at least one of the inputs from a camera and a microphone. The method also includes transmitting the extracted feature information to a server. The method also includes receiving, from the server, at least one of information and a memo associated with an SNS user who matches the extracted feature information. The method also includes displaying at least one of the received information and the received memo.

A method and apparatus according to the present disclosure determine a face of a subject through a camera, and determine a feature of a partner. Alternatively, the partner may be determined by sensing a voice. The method according to the present disclosure determines a partner through the described method, and provides an SNS associated with the partner in real time so as to readily connect and extend an online relationship to an offline relationship. Further, by setting a range of the disclosure of personal information, the user may protect the personal information or may execute other functions using the same.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a social network service providing system using an electronic device according to an embodiment of the present disclosure;

FIG. 2 illustrates a block diagram of an electronic device according to an embodiment of the present disclosure;

FIG. 3 illustrates a diagram of a process of displaying information and a memo according to an embodiment of the present disclosure;

FIG. 4 illustrates a process of displaying information and a memo according to an embodiment of the present disclosure;

FIG. 5 illustrates a setting process of a social network server according to an embodiment of the present disclosure;

FIG. 6 illustrates a process of storing a memo according to an embodiment of the present disclosure;

FIG. 7 illustrates is a diagram of an operation of recognizing a feature of a subject, and an operation of displaying information according to an embodiment of the present disclosure;

FIG. 8 illustrates a diagram of an operation of recognizing a feature of multiple subjects, and an operation of displaying information according to an embodiment of the present disclosure;

FIG. 9 illustrates a diagram of an operation of recognizing a feature of a subject, and an operation of displaying information and a memo according to an embodiment of the present disclosure;

FIG. 10 illustrates a diagram of an operation of recognizing a feature of a subject, and an operation of displaying information and a memo according to another embodiment of the present disclosure;

FIGS. 11A and 11B illustrate diagrams of an operation of recognizing a feature of a subject and an operation of displaying information and a memo according to another embodiment of the present disclosure;

FIGS. 12A and 12B illustrate diagrams of an operation of recognizing a feature of a subject, and an operation of inputting a memo according to an embodiment of the present disclosure; and

FIGS. 13A and 13B illustrate diagrams of an operation of recognizing a feature of a subject, and an operation of inputting a memo according to another embodiment of the present disclosure.

### DETAILED DESCRIPTION

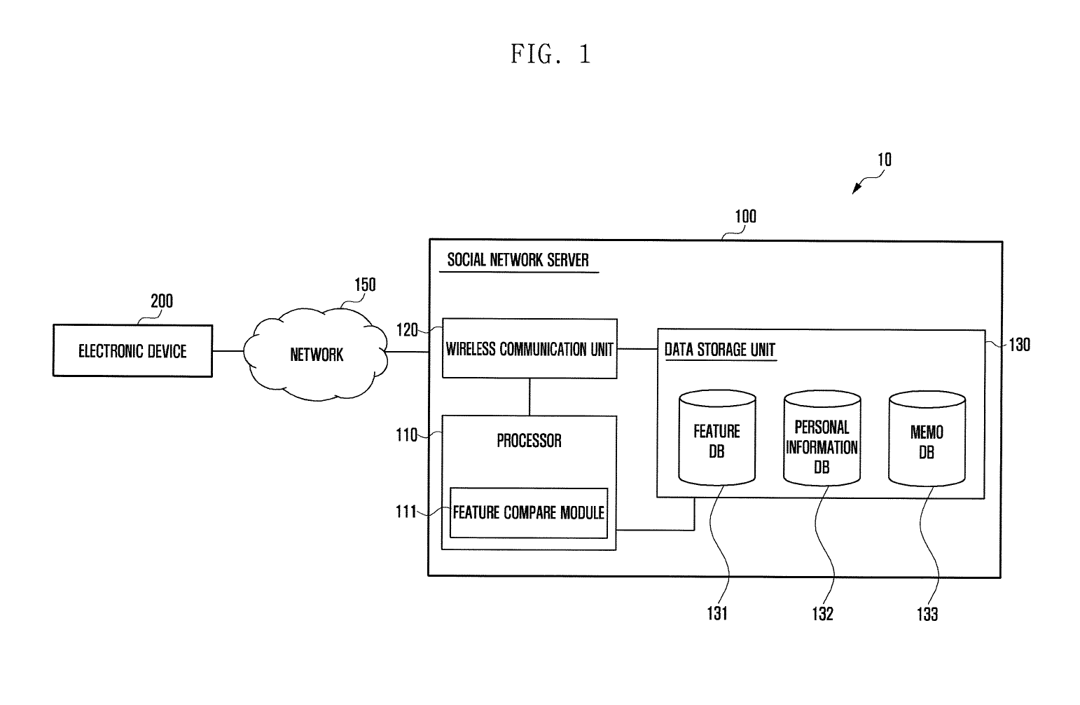

FIGS. 1 through 13B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Hereinafter, various embodiments will be described in detail with reference to the accompanying drawings. It should be noted that the same elements will be designated by the same reference numerals although they are shown in different drawings. Further, a detailed description of a known function and configuration which may make the subject matter of the present disclosure unclear will be omitted. Hereinafter, it should be noted that only the descriptions will be provided that may help understanding the operations provided in association with the various embodiments of the present disclosure, and other descriptions will be omitted to avoid making the subject matter of the present disclosure rather unclear.

An electronic device according to the present disclosure may be a device including a communication function. For example, the device corresponds to a combination of at least one of a smartphone, a tablet Personal Computer (PC), a mobile phone, a video phone , an e-book reader, a desktop PC, a laptop PC, a netbook computer, a personal digital assistant (PDA), a portable multimedia player (PMP), an MP3 player, a mobile medical device, an electronic bracelet, an electronic necklace, an electronic appcessory, a camera, a wearable device, an electronic clock, a wrist watch, home appliances (for example, an air-conditioner, vacuum, an oven, a microwave, a washing machine, an air cleaner, and the like), an artificial intelligence robot, a TV, a digital video disk (DVD) player, an audio device, various medical devices (for example, magnetic resonance angiography (MRA), magnetic resonance imaging (MRI), computed tomography (CT), a scanning machine, a ultrasonic wave device, or the like), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, vehicle infotainment device, an electronic equipment for ship (for example, navigation equipment for ship, gyrocompass, or the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present disclosure is not limited to the aforementioned devices.

FIG. 1 illustrates a configuration of a Social Network Service (SNS) providing system using an electronic device according to an embodiment of the present disclosure.

Referring to FIG. 1, the SNS providing system may include a social network server 100, a network 150, and an electronic device 200.

The social network server 100 may include a processor 110, a wireless communication unit 120, and a data storage unit 130. The processor 110 receives a command from the described other component elements (for example, the wireless communication unit 120 and the data storage unit 130), interprets the received command, and executes an operation or data processing as per the interpreted command The processor 110 may include a feature compare module 111.

The feature compare module 111 may receive a feature of an extracted subject from the electronic device 200, and compare the feature with data stored in a feature DB 131 of the data storage unit 130. Here, it is determined whether a feature identical to the extracted feature of the subject that is transferred from the electronic device 200 exists in the feature DB 131. When the identical feature exists, an SNS user having the feature may be retrieved, and information associated with the SNS user among the information stored in personal information DB 132 may be transmitted to the electronic device 200 by controlling the wireless communication unit 120.

The term “module” used in the present disclosure may refer to, for example, a unit including one or more combinations of hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which have been known or are to be developed hereinafter.

The wireless communication unit 120 may connect the communication between electronic devices or the communication between a server and an electronic device. The communication module 120 may support a short-range communication protocol (for example, Wi-Fi, Bluetooth (BT), or Near Field Communication (NFC)) or communication of a predetermined network 150 (for example, the Internet, a Local Area Network (LAN), a Wire Area Network (WAN), a telecommunication network, a cellular network, a satellite network, a Plain Old Telephone Service (POTS), or the like).

The data storage unit 130 may include the feature DB 131, the personal information DB 132, and a memo DB 133.

The processor 110 of the social network server 100 may receive features extracted from faces and voices of SNS users from the electronic device 200 over the network 150, using the wireless communication unit 120, and store the same in the feature DB 131.

The personal information DB 132 may be classified into at least one group, and personal information of each group may be classified by a security level. The processor 110 may transmit personal information associated with an SNS user as per a request of a user, when the request of the user is recognized.

The processor 110 of the social network server 100 may store, in the memo DB 133, a memo transmitted from the electronic device 200. Also, the processor 110 of the social network server 100 may recognize a request for comparing a feature of a subject and a feature of an SNS user, search for an SNS user having an identical feature, and search for a memo associated with the SNS user from the memo DB 133 so as to transmit the same to the electronic device. 200.

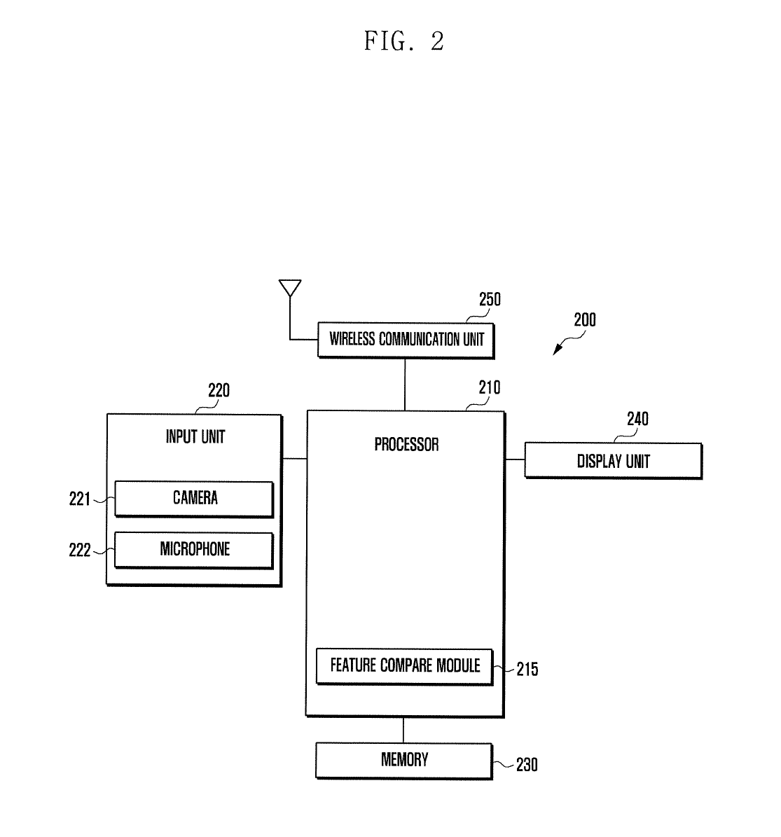

FIG. 2 illustrates a block diagram of an electronic device according to an embodiment of the present disclosure.

Referring to FIG. 2, the electronic device 200 may include a processor 210, an input unit 220, a memory 230, a display unit 240, and a wireless communication unit 250.

The processor 210 may receive a command from the described other component elements (for example, the input unit 220, the memory 230, the display unit 240, and the wireless communication unit 250), interpret the received command, and execute an operation or data processing as per the interpreted command. The processor 210 may include a feature compare module 215.

The feature compare module 215 may receive a feature of a subject from the input unit 220. Further, the feature compare module 215 may extract the received feature of the subject, and transmit the extracted feature information to the social network server 100 through the wireless communication unit 250.

The input unit 220 may include a camera 221 and a microphone 222. The camera 221 is a device capable of photographing a still image and a moving image, and may include an image sensor (for example, a rear lens), an Image Signal Processor (ISP; not illustrated), or a flash LED (not illustrated) according to an embodiment. The camera 221 may be used for recording a video, photographing a picture, or executing a video call, through a lens installed in the electronic device 200.

The microphone 222 may be installed in the electronic device 200. The microphone 222 may include an omni-directional microphone or a directional microphone. The directional microphone may intensively receive a voice signal of a predetermined direction. The feature compare module 215 may extract an identifier of an SNS user from among voice signals input from the microphone 222. The identifier may be a word used for identifying an SNS user, for example, a name, identification (ID), or the like. The feature compare module 215 may transmit the extracted identifier by controlling the wireless communication unit 250, so as to request the social network server 100 to execute a search through comparison. To download information associated with an SNS user having an identical feature to a subject from the social network server 100, the wireless communication unit 250 may be controlled.

The memory 230 may store a command or data that may be received from or generated by the processor 210 or other component elements. The memory 230 may include, for example, a kernel, middle ware, an Application Programming Interface (API), an application, and the like. For example, the memory 230 may store an image obtained by photographing a subject through the camera 221 of the input unit 220, and voice signals input through the microphone 222.

The display unit 240 may display information processed in the electronic device 200. For example, the display unit 240 may output information and a memo associated with an SNS, transferred from the social network server 100, and simultaneously, may output a subject image photographed by the camera 221.

As described in the above, the display unit 240 may be used as the input unit 220. The display unit 240 may include at least one of a Liquid Crystal Display (LCD), a Thin Film Transistor-Liquid Crystal Display (TFT LCD), an Organic Light-Emitting Diode (OLED), a flexible display, and a three-dimensional (3D) display. Two or more display units 240 may exist, depending on an embodiment form of the electronic device 200.

The wireless communication unit 250 may connect the communication between electronic devices or the communication between a server and an electronic device. The communication module 250 may support a short-range communication protocol (for example, Wi-Fi, Bluetooth (BT), or Near Field Communication (NFC)) or communication through a predetermined network (for example, the network 150) (for example, the Internet, a Local Area Network (LAN), a Wire Area Network (WAN), a telecommunication network, a cellular network, a satellite network or a Plain Old Telephone Service (POTS), or the like).

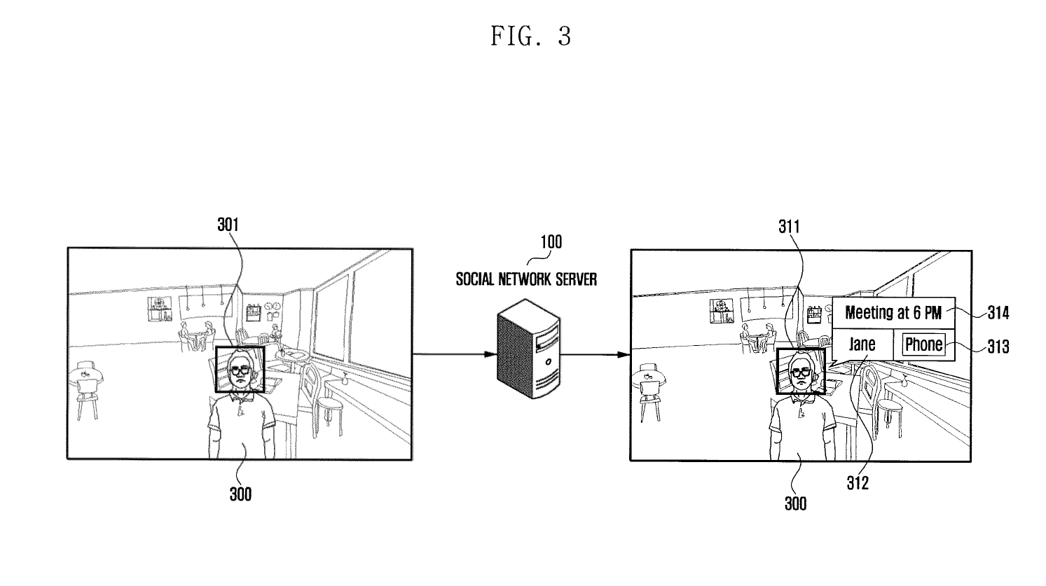

FIG. 3 illustrates a diagram of a process of displaying information and a memo according to an embodiment of the present disclosure.

Referring to FIG. 3, the processor 210 of the electronic device 200 may display a screen of recognizing a subject 300 by controlling the display unit 240. The processor 210 of the electronic device 200 may display a contour 301 and 311 when a feature of the subject 300 is detected. The processor 210 of the electronic device 200 may detect the feature of the subject 300. The processor 210 of the electronic device 200 may control the wireless communication unit 250, so as to transmit the detected features to the social network server 100 through the wireless communication unit 250. The processor 110 of the social network server 100 may execute a search for an SNS user having an identical feature to the detected feature of the subject 300, from the feature DB 131 of the data storage unit 130. The processor 110 of the social network server 100 searches for the SNS user having the identical feature, and when the SNS user exists, may transmit the information 312 and 313 associated with the corresponding SNS user, and a memo 314 input in advance from the electronic device 200, to the electronic device 200, through the wireless communication unit 120 of the social network server 100. The processor 210 of the electronic device 200 may download the information 312 and 313 associated with the SNS user and the memo 314, from the social network server through the wireless communication unit 250. The processor 210 of the electronic device 200 may control the display unit 240, so as to display the information 312 and 313, and the memo 314 associated with the SNS user whom a user encounters in reality, that is, the SNS user having the feature of the subject 300 that is photographed by the camera 221.

The processor 210 of the electronic device 200 may output an SNS user information display screen based on the SNS user information 312 and 313 downloaded from the social network server 100, by controlling the display unit 240. The SNS user information 312 and 313 may include, for example, an identifier of an SNS user, that is, information indicating an ID or a name, and information that is set by an SNS user in advance to be disclosed to a user of an electronic device that recognizes the SNS user. In addition to the information 312 and 313, the memo 314 that is input by the user of the electronic device 200 in advance in association with the SNS user may be displayed. Although not illustrated, the processor 210 of the electronic device 200 may simultaneously display a plurality of pieces of information and a plurality of memos.

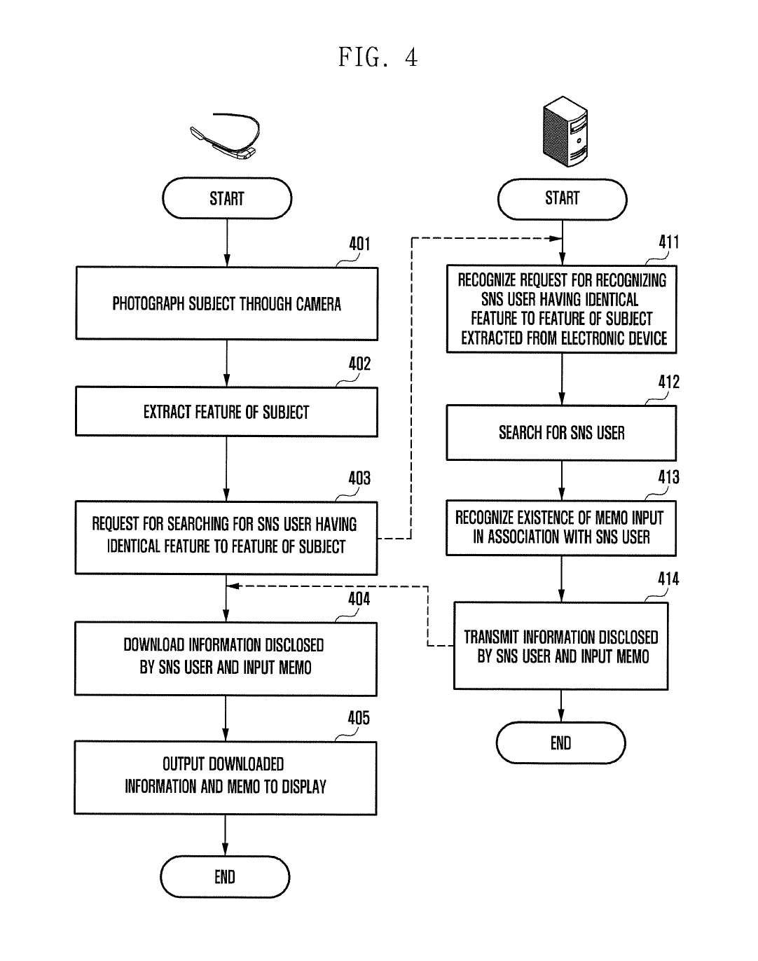

FIG. 4 illustrates a process of displaying information and a memo according to an embodiment of the present disclosure.

Referring to FIG. 4, in operation 401, the processor 210 of the electronic device 200 may control the camera 221, so as to photograph a subject. Here, the electronic device 200 and the processor 210 may be the electronic device 200 and the processor 210 of FIG. 2. In operation 402, the processor 210 of the electronic device 200 may extract a feature of the photographed subject. Here, the feature may be an outward feature of the subject, for example, eyes, a nose, a mouth, and features of a face. Further, an identifier extracted from among voice signals input through the microphone 222 in association with the subject, may be the feature. Based on the extracted feature information, the processor 210 of the electronic device 200 may request the social network server 100 to search for an SNS user having an identical feature to the extracted feature information, in operation 403.

In operation 404, the processor 210 of the electronic device 200 may download, from the social network server 100, information disclosed by the SNS user and a memo left for the SNS user. In operation 405, the processor 210 of the electronic device 200 may control the display unit 240, so as to output the downloaded information and memo.

In response to the operation of the electronic device 200, the social network server 100 may operate as follows. In operation 411, the processor 110 of the social network server 100 may recognize an SNS user search request for searching for an SNS user having the identical feature information to the feature information of the subject extracted from the electronic device 200. In operation 412, the processor 110 of the social network server 100 may search for the SNS user based on the extracted feature information. When the SNS user having the identical feature information exists in operation 412, the processor 110 of the social network server 100 may determine whether a memo input in association with the SNS user exists. When the processor 110 of the social network server 100 determines that the input memo exists, the processor 110 of the social network server 100 may transmit, to the electronic device 200, information disclosed by the SNS user and the input memo, in operation 414.

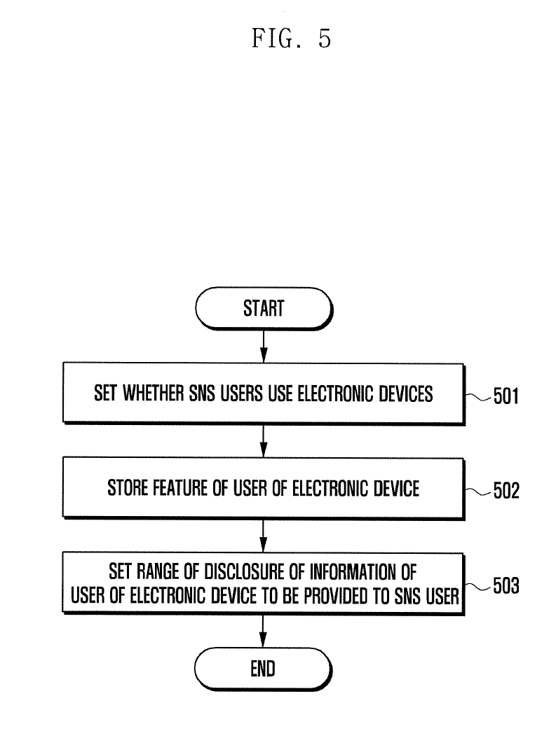

FIG. 5 illustrates a setting process of a social network server according to an embodiment of the present disclosure.

Referring to FIG. 5, in operation 501, the processor 110 of the social network server 100 may provide a user with an environment where the user may determine whether SNS users use the electronic device 200. For example, the processor 110 of the social network server 100 may provide information associated with whether the SNS users possess the electronic device 200, and accordingly, the user sets whether to communicate with the electronic device 200 of the SNS users, and may communicate with the SNS users who have the electronic device 200 for which the communication is set.

In operation 502, the processor 110 of the social network server 100 may store feature information of a user of the electronic device 200, in the feature DB 131 of the data storage unit 130. The processor 110 of the social network server 100 stores the feature information of the user of the electronic device 200 in the feature DB 131 of the data storage unit 130, and the processor 110 may compare feature information of a user detected by a processor of another electronic device with the data stored in the feature DB 131 of the data storage unit 130. When the feature information of the user and the data stored in the feature DB of the data storage unit 131 are identical, the SNS information associated with the recognized user may be provided.

In operation 503, the processor 110 of the social network server 100 may set a range of disclosure of information associated with a user who uses the electronic device 200. The processor 110 of the social network server 100 may set the range of disclosure of information of a user who uses the electronic device 200 for each SNS user, and may group SNS users and set the range for each group. For example, the processor 110 of the social network server 100 may set a few SNS users as a group named ‘family’, as per a request of a user who uses the electronic device 200. Accordingly, the processor 110 of the social network server 100 may set the range of disclosure of information of a user, such that a name, an age, an e-mail address, and a blood type are disclosed to an SNS user having another electronic device, among the information 312 and 313 associated with the user who uses the electronic device 200, which is requested by the user.

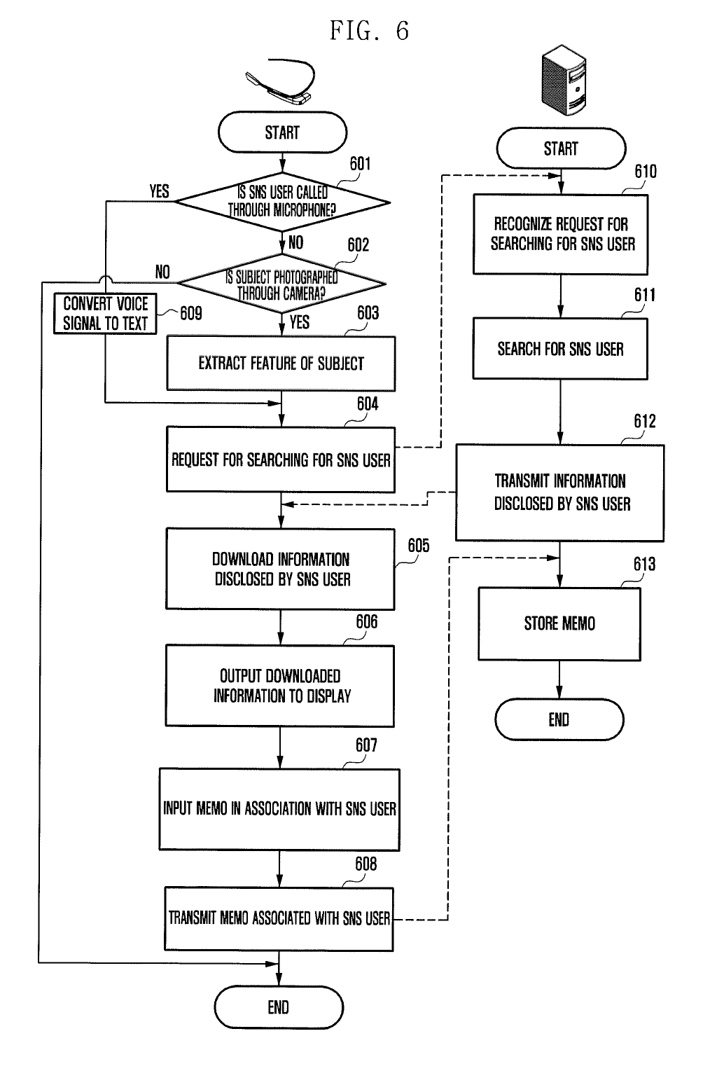

FIG. 6 illustrates a process of storing a memo according to an embodiment of the present disclosure.

Referring to FIG. 6, in operation 601, the processor 210 of the electronic device 200 may determine whether an SNS user is called by receiving a voice signal input through the microphone 222 of an input unit. When it is determined that the SNS user is not called, the process proceeds with operation 602. In operation 602, the processor 210 of the electronic device 200 may photograph a subject through the camera 221 of the input unit and receive the photographed image, so as to determine whether or not the subject is captured. When it is determined that the subject is not photographed, the processor 210 of the electronic device 200 may terminate the process. When it is determined that the subject is photographed, the processor 210 of the electronic device 200 may proceed with operation 603. Further, when the processor 210 of the electronic device 200 determines an SNS user call based on an input of a voice signal through a microphone, that is, when an identifier associated with a subject exists among voice signals, in operation 601, the process may proceed with operation 609. The electronic device 200 may convert the input voice signal into text. In operation 604, the processor 210 of the electronic device 200 may extract feature information of the photographed subject or may extract an identifier, that is, feature information among the converted voice signals. The feature compare module 215 of the electronic device 200 may search for feature information identical to the feature information of the subject extracted through calling or photographing in operation 604, from SNS user feature information stored in the feature DB 131 of the social network server 100. The feature compare module 215 of the electronic device 200 may request the social network server 100 to search for the identical feature information. In operation 605, the processor 210 of the electronic device 200 may receive the information 312 and 313 associated with the SNS user having the identical feature information from the social network server 100, through the wireless communication unit 250. Here, the information 312 and 313 associated with the SNS user may be different based on the range of disclosure of information set in advance by the SNS user.

In operation 606, the processor 210 of the electronic device 200 may transfer a display command signal to the display unit 240, so as to display the downloaded information 312 and 313 associated with the SNS user. In response to this, the display unit 240 may receive the display command signal under a control of the processor 210 of the electronic device 200, and may display the information 312 and 313 associated with the SNS user. In operation 607, the processor 210 of the electronic device 200 may input a memo associated with an SNS user, based on the downloaded information associated with the SNS user. The processor 210 of the electronic device 200 may control the microphone 222 of the input unit 220, so as to receive a voice signal. The processor 210 of the electronic device 200 may process the received voice signal into text, and store the same in the memory 230. In operation 608, the processor 210 of the electronic device 200 may control the wireless communication unit 250, so as to transmit the content stored in the memory 230 to the social network server 100.

In response to the operation of the electronic device 200, the social network server 100 may operate as follows. In operation 610, the processor 110 of the social network server 100 may recognize an SNS user search request for searching for an SNS user having the identical feature information to the subject, from the processor 210 of the electronic device 200. In operation 611, the processor 110 of the social network server 100 may search for the SNS user in response to the SNS user search request. The processor 110 of the social network server 100 may execute a search, based on the data stored in the feature DB 131 of the data storage unit 130. In operation 612, the processor 110 of the social network server 100 may transmit, to the electronic device 200, information disclosed by the retrieved SNS user. The information disclosed by the SNS user may be information stored in the personal information DB 132. In operation 613, the processor 110 of the social network server 100 may store a memo received from the processor 210 of the electronic device 200, in the memo DB 133 of the data storage unit 130.

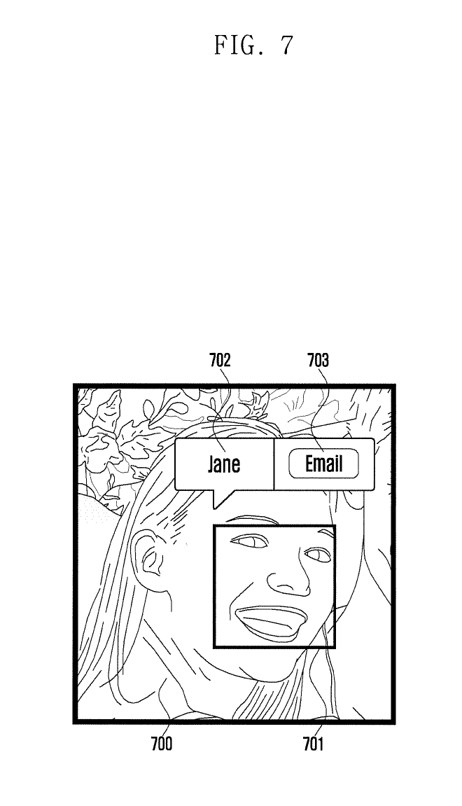

FIG. 7 illustrates a diagram of an operation of recognizing a feature of a subject and an operation of displaying information according to an embodiment of the present disclosure.

Referring to FIG. 7, when the processor 210 of the electronic device 200 photographs a subject 700 by controlling the camera 221 and detects feature information of the subject 700, the processor 210 of the electronic device 200 may display a contour 701. The processor 210 of the electronic device 200 may display the contour 701 of the subject 700, and detect feature information. The processor 210 of the electronic device 200 may transmit the detected feature information to the social network server 100 by controlling the wireless communication unit 250. The processor 110 of the social network server 100 may receive the detected feature information of the subject 700 through the wireless communication unit 120, which is transmitted from the electronic device 200, and compares the same with data of the feature DB 131 of the data storage unit 130. The processor 110 of the social network server 100 compares the detected feature and the data, and when feature information of an identical SNS user exists, may control the wireless communication unit 120, so as to transmit information 702 and 703 associated with the SNS user to the electronic device 200. The processor 210 of the electronic device 200 may control the display unit 240, so as to display the information associated with the SNS user, which is received through the wireless communication unit 250, and a memo, together with the subject 700 which is preview image input from the camera 221. The SNS user information 702 may include an identifier of an SNS user, that is, information, ‘Jane’, indicating an ID or a name, and information 703, ‘E-mail’, which is set by an SNS user in advance to be disclosed to a user of an electronic device that recognizes the SNS user. The information 703 may be displayed to be ‘E-mail’ and may need an additional selection of the user of the electronic device 200, or may be displayed to be ‘jane@gmail.com’, as detailed information.

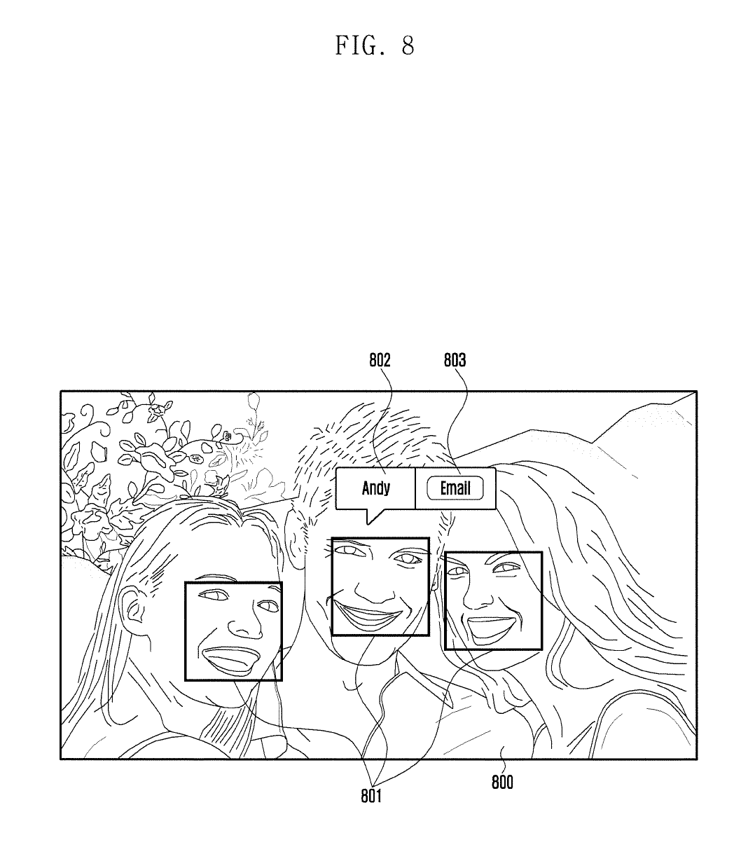

FIG. 8 illustrates a diagram of an operation of recognizing a feature of multiple subjects and an operation of displaying information according to an embodiment of the present disclosure.

Referring to FIG. 8, when the processor 210 of the electronic device 200 photographs subjects 800 by controlling the camera 221, the processor 210 of the electronic device 200 may display a contour 801 that detects feature information of the subjects 800. The processor 210 of the electronic device 200 may detect the feature information of a subject 800 which is displayed close to the center of the screen from among the subjects 800. The processor 210 of the electronic device may control the wireless communication unit 250, so as to transmit, to a server, the feature information detected based on at least one of the subjects 800. The processor 110 of the social network server 100 may execute a search by comparing the detected feature information of the subject 800, transmitted from the electronic device 200, with data of the feature DB 131 of the data storage unit 130. The processor 110 of the social network server 100 compares the detected feature and the data of the feature DB 131, and when feature information of an identical SNS user exists, may control the wireless communication unit 120, so as to transmit information associated with the SNS user and a memo input in advance, to the electronic device 200. The processor 210 of the electronic device 200 may control the display unit 240, so as to display the information 802 and 803 associated with the SNS user and the memo (not illustrated) which are received through the wireless communication unit 250, together with the subject 800 which is preview image input from the camera 221. The SNS user information (for example, a name 802 or an e-mail 803) may include an identifier of an SNS user, that is, information 802, ‘Andy’, indicating an ID or a name, and information 803, ‘E-mail’, which is set by an SNS user in advance to be disclosed to a user of the electronic device 200 that recognizes the SNS user. The information 803 may be displayed to be ‘E-mail’ and may need an additional selection of the user of the electronic device 200, or may be displayed to be ‘Andy@gmail.com’, as detailed information.

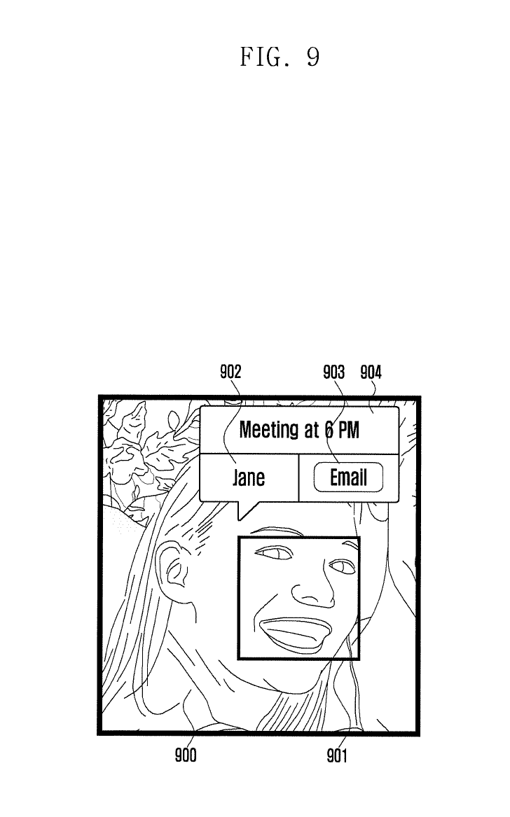

FIG. 9 illustrates a diagram of an operation of recognizing subject feature information and an operation of displaying information and a memo according to an embodiment of the present disclosure.

Referring to FIG. 9, when the processor 210 of the electronic device 200 photographs a subject 900 by controlling the camera 221, the processor 210 of the electronic device 200 may display a contour 901 that detects feature information of the subject 900. The processor 210 of the electronic device 200 may display the contour 901 of the subject 900, and detect feature information. The processor 210 of the electronic device 200 may transmit the detected feature information to the social network server 100 by controlling the wireless communication unit 250. The processor 110 of the social network server 100 may execute a search by comparing the detected feature information of the subject 900, transmitted from the electronic device 200, with data of the feature DB 131 of the data storage unit 130. The processor 110 of the social network server 100 compares the detected feature information and the data, and when feature information of an identical SNS user exists, may control the wireless communication unit 120, so as to transmit information 902 and 903 associated with the SNS user and a memo 904 input in advance, to the electronic device 200. The processor 210 of the electronic device 200 may control the display unit 240, so as to display the information 902 and 903 associated with the SNS user and the memo 904 which are transferred from the wireless communication unit 120, together with the subject 900 which is preview image input from the camera 221. The SNS user information 902 and 903 may include, for example, an identifier of an SNS user, that is, information 902, ‘Jane’, indicating an ID or a name, and information 903, ‘E-mail’, which is set by an SNS user in advance to be disclosed to a user of the electronic device 200 that recognizes the SNS user. The information 903 may be displayed to be ‘E-mail’ and may need an additional selection of the user of the electronic device 200, or may be displayed to be ‘jane@gmail.com’, as detailed information. Further, in addition to the information, the memo 904 ‘Meeting at 6 PM’ which is input in advance by the user of the electronic device 200 in association with the SNS user may be displayed together with the information 902 and 903.

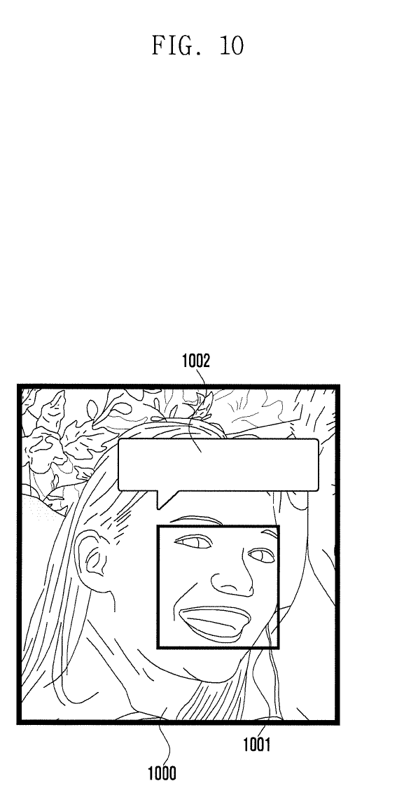

FIG. 10 illustrates a diagram of an operation of recognizing a feature of a subject and an operation of displaying information and a memo according to another embodiment of the present disclosure.

Referring to FIG. 10, when the processor 210 of the electronic device 200 photographs a subject 1000 through the camera 221, the processor 210 of the electronic device 200 may display a contour 1000 that detects feature information of the subject 1000. The processor 210 of the electronic device 200 may display the contour 1001 of the subject 1000, and detect feature information. The processor 210 of the electronic device 200 may transmit the detected feature information to the social network server 100 by controlling the wireless communication unit 250. The processor 110 of the social network server 100 may execute a search by comparing the detected feature information of the subject 1000, transmitted from the electronic device 200, with data of the feature DB 131 of the data storage unit 130. The processor 110 of the social network server 100 compares the detected feature information and the data, and when feature information of an identical SNS user exists, may control the wireless communication unit 120, so as to transmit information 1002 associated with the SNS user and a memo (not illustrated) input in advance, to the electronic device 200. The processor 210 of the electronic device 200 may control the display unit 240, so as to display the information 1002 associated with the SNS user and a memo (not illustrated), which is received through the wireless communication unit 250 together with the subject 1000 which is preview image input from the camera 221. Referring to FIG. 10, the information 1002 associated with the SNS user, which is a subject, may be displayed to a user based on the range of disclosure of information. That is, the information 1002 associated with the SNS user may not be disclosed to the user of the electronic device 200.

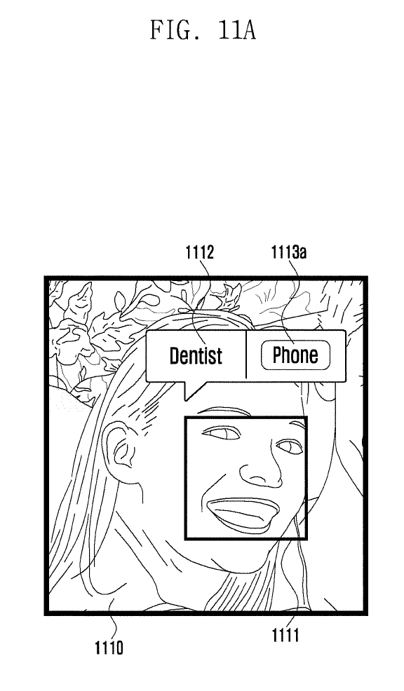

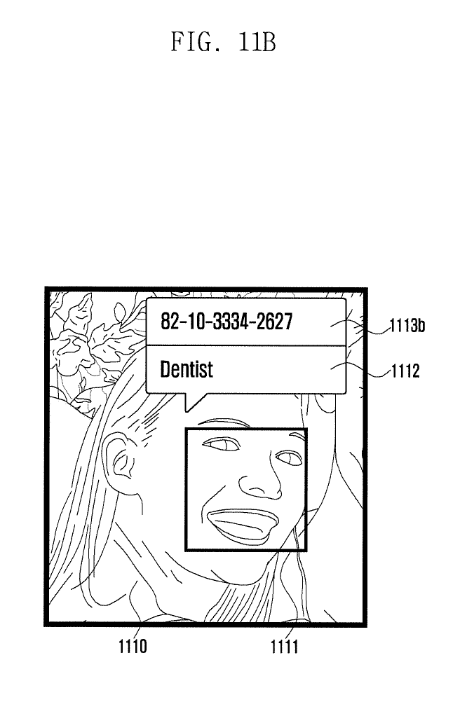

FIGS. 11A and 11B illustrate diagrams of an operation of recognizing a feature of a subject and an operation of displaying information and a memo according to another embodiment of the present disclosure.

Referring to FIG. 11A, when the processor 210 of the electronic device 200 photographs a subject 1110 by controlling the camera 221, the processor 210 of the electronic device 200 may display a contour 1111 that detects feature information of the subject 1110. The processor 210 of the electronic device 200 may display the contour 1110 of the subject 1111, and detect feature information. The processor 210 of the electronic device 200 may transmit the detected feature information to the social network server 100 by controlling the wireless communication unit 250. The processor 110 of the social network server 100 may receive the detected feature information of the subject 1110 through the wireless communication unit 120, which is transmitted from the electronic device 200, and compares the same with data of the feature DB 131 of the data storage unit 130. The processor 110 of the social network server 100 compares the detected feature information and the data, and when feature information of an identical SNS user exists, may control the wireless communication unit 120, so as to transmit information 1112 and 1113 associated with the SNS user and a memo (not illustrated) input in advance, to the electronic device 200. The processor 210 of the electronic device 200 may control the display unit 240, so as to display the information 1112 and 1113 associated with the SNS user and a memo, which is received through the wireless communication unit 250, together with the subject 1110 which is preview image input from the camera 221. The information associated with the SNS user may include the information 1112, Dentist', indicating an occupation, and the information 1113, ‘Phone’, indicating contact information disclosed by the SNS user. As shown in FIG. 11A, information 1113a may be displayed to be ‘Phone’ and may need an additional selection of a user of the electronic device 200. Alternatively, as shown in FIG. 11B, information 1113b may be displayed to be ‘82-10-3334-2627’, as detailed information.

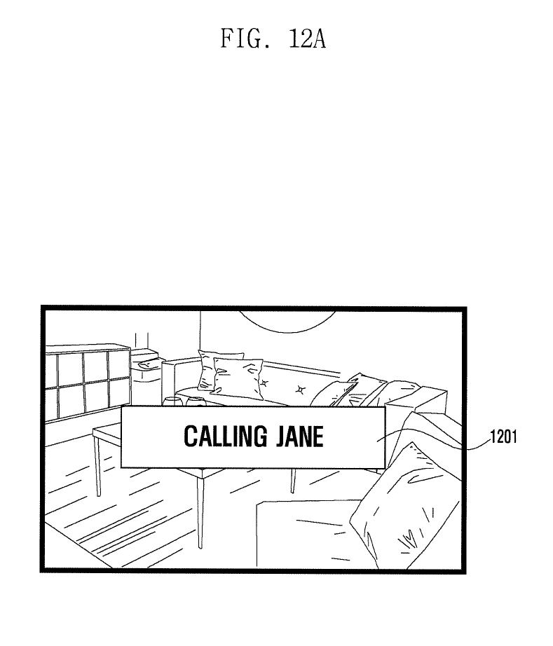

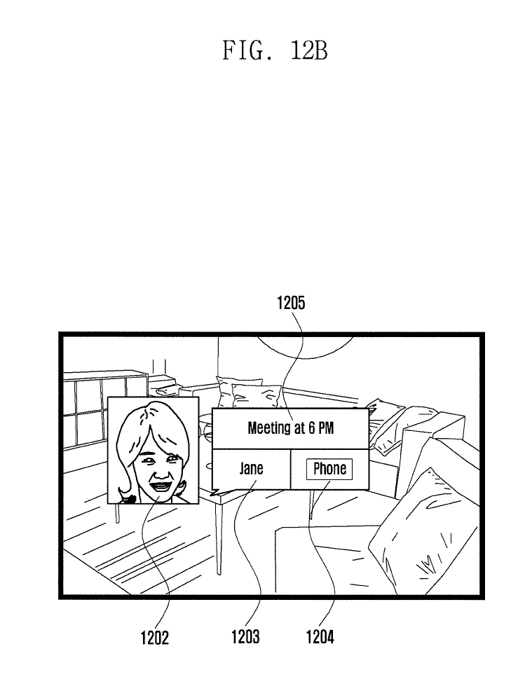

FIG. 12 illustrates a diagram of an operation of recognizing subject feature information and an operation of inputting a memo according to an embodiment of the present disclosure.

Referring to FIG. 12A, the processor 210 of the electronic device 200 may call an SNS user through a voice signal as shown in the diagram 1201, irrespective of the existence of a subject, so as to display information associated with the SNS user or to input a memo. The processor 210 of the electronic device 200 may detect an identifier of the SNS user from among voice signals of the user, which are input through the microphone 222. The processor 210 of the electronic device 200 may receive, from the microphone 222, a voice signal of the user, which is used for calling an SNS user having an identifier of ‘Jane’. The processor 210 of the electronic device 200 may control the display unit 240 to display a message of ‘calling Jane’. The processor 210 of the electronic device 200 may transmit the detected identifier to the social network server 100 by controlling the wireless communication unit 250. The processor 210 of the electronic device 200 converts the detected voice signal into text for transmitting to the social network server 100, and controls the wireless communication unit 250 to transmit the same to the social network server 100. The processor 110 of the social network server 100 may receive the detected feature information, which is converted into text, through the wireless communication unit 120, and compare the detected feature information transmitted from the electronic device 200 with data of the feature DB 131 of the data storage unit 130. The processor 110 of the social network server 100 compares the detected feature information and the data of the feature DB 131, and determines whether feature information of an identical SNS user exists in the feature DB 131. When the feature information of the identical SNS user exists in the feature DB 131, information associated with the SNS user may be selected from the personal DB 132, and a memo input in advance may be selected from the memo DB 133. The processor 110 of the social network server 100 may control the wireless communication unit 120, so as to transmit the SNS user information and the memo to the electronic device 200.

Referring to FIG. 12B, the processor 210 of the electronic device 200 may control the display unit 240 so as to display the information 1203 and 1204 associated with the SNS user and a memo, which are received through the wireless communication unit 250. In this example, the processor 210 of the electronic device 200 may output information 1202 associated with features of a face of the SNS user, in addition to the information 1203 and 1204 associated with the SNS user and the memo. The SNS user information 1203 and 1204 may include, for example, an identifier of an SNS user, that is, ‘Jane’ indicating an ID or a name, and ‘Phone’, which is set by an SNS user in advance to be disclosed to a user of the electronic device 200 that recognizes the SNS user. The processor 210 of the electronic device 200 may display a part of the information to be ‘Phone’, and may control the display unit 240 so as to provide an output that enables the user of the electronic device 200 to provide an additional selection. Further, the processor 210 of the electronic device 200 may display ‘82-10-3334-2627’ as detailed information.

The processor 210 of the electronic device 200 receives, from the microphone 222, a voice signal for a user of the electronic device 200 to input a memo 1205, converts the voice signal into text, and stores the same in the memory 230. Also, simultaneously, the processor 210 of the electronic device 200 may control the display unit 240, so as to output the memo 1205 which is converted into text and stored in the memory 230. The processor 210 of the electronic device 200 may request the memo DB 133 of the social network server 100 to store the memo 1205 which is input through the microphone 222 and converted into text. The processor 210 of the electronic device 200 may transmit the memo 1205 to the social network server 100 by controlling the wireless communication unit 250. The processor 110 of the social network server 100 may store, in the memo DB 133, the memo 1205 of the electronic device 200, which is received through the wireless communication unit 120.

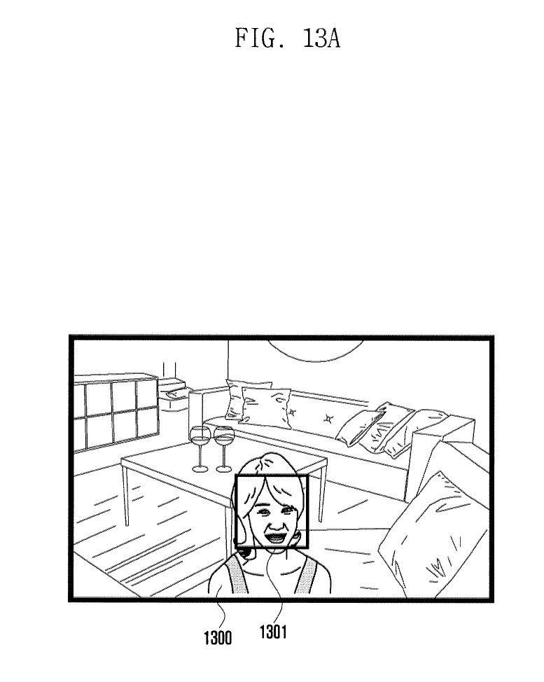

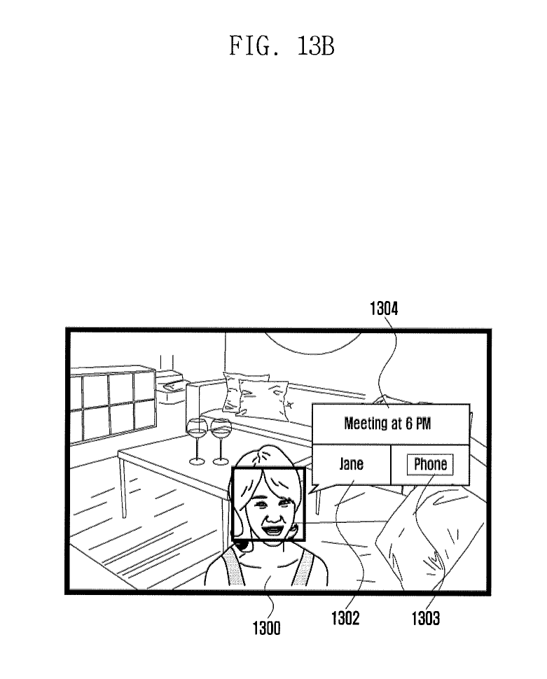

FIG. 13 illustrate a diagram of an operation of recognizing subject feature information and an operation of inputting a memo according to an embodiment of the present disclosure.

Referring to FIG. 13, when the processor 210 of the electronic device 200 photographs a subject 1300 by controlling the camera 221, the processor 210 of the electronic device 200 may display a contour 1301 that detects feature information of the subject 1300. The processor 210 of the electronic device 200 may display the contour 1301 of the subject 1300, and detect feature information. The processor 210 of the electronic device 200 may transmit the detected feature information to the social network server 100 by controlling the wireless communication unit 250. The processor 110 of the social network server 100 may receive the detected feature information of the subject 1300 through the wireless communication unit 120, which is transmitted from the electronic device 200, and compares the same with data of the feature DB 131 of the data storage unit 130. The processor 110 of the social network server 100 compares the detected feature and the data, and when feature information of an identical SNS user exists, may control the wireless communication unit 120, so as to transmit information 1302 and 1303 associated with the SNS user to the electronic device 200.

Referring to FIG. 13B, the processor 210 of the electronic device 200 may control the display unit 240, so as to display information associated with an SNS user, that is, a subject 1300 received from the social network server 100. The processor 210 of the electronic device 200 may input a memo 1304, with reference to information 1302 and 1303 associated with the SNS user, that is, the subject 1300. The processor 210 of the electronic device 200 may input the memo 1304 by recognizing a voice signal input through the microphone 222. The processor 210 of the electronic device 200 may convert the input voice signal into text, and store the same in the memory 230. The processor 210 of the electronic device 200 may control the display unit 240, so as to display, on a screen, the memo 1304 stored in the memory 230.

The processor 210 of the electronic device 200 may request the memo DB 133 of the social network server 100 to store the memo 1304 which is input through the microphone 222. The processor 210 of the electronic device 200 may transmit the memo 1304 to the social network server 100 by controlling the wireless communication unit 250. The processor 110 of the social network server 100 may store, in the memo DB 133, the memo 1304 of the electronic device 200 which is received through the wireless communication unit 120.

The method according to the present disclosure as described above may be implemented as a program command which can be executed through various computers and recorded in a computer-readable recording medium. The recording medium may include a program command, a data file, and a data structure. Further, the program command may be specially designed and configured for the present disclosure or may be used after being known to those skilled in computer software fields. The recording medium may include magnetic media such as a hard disk, a floppy disk and a magnetic tape, optical media such as a Compact Disc Read-Only Memory (CD-ROM) and a Digital Versatile Disc (DVD), magneto-optical media such as a floptical disk, and hardware devices such as a Read-Only Memory (ROM), a Random Access Memory (RAM) and a flash memory. In addition, the program instructions may include high class language codes, which can be executed in a computer by using an interpreter, as well as machine codes made by a compiler.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing a Social Network Service (SNS) using an electronic device, the method comprising:
extracting feature information from at least one of the inputs from a camera and a microphone;
transmitting the extracted feature information to a server;
receiving, from the server, at least one of information and a memo associated with an SNS user who matches the extracted feature information; and
displaying at least one of the received information and the received memo.

2. The method of claim 1, wherein extracting comprises at least one of:
extracting facial feature information of a subject from the feature information input from the camera; and
converting a voice signal input from the microphone into text, and extracting feature information.

3. The method of claim 1, wherein receiving comprises:
executing reception when a range of the information associated with the SNS user is set by the SNS user.

4. The method of claim 1, wherein receiving comprises:
executing reception when a memo is input in association with the SNS user.

5. The method of claim 4, wherein inputting the memo comprises:
when information indicating that the SNS user who matches the extracted feature exists is received from the server, inputting a memo associated with the SNS user by inputting a voice signal through the microphone.

6. The method of claim 1, wherein displaying comprises:
displaying at least one of the information and the memo, together with a subject input from the camera.

7. The method of claim 1, wherein displaying comprises:
displaying at least one of the information and the memo, together with the feature information of the SNS user.

8. A Social Network Service (SNS) electronic device, comprising:
a displaying unit configured to display feature information and a memo, input from at least one of a camera and a microphone;
an input unit including the camera and the microphone;
a memory configured to store the memo; and
a processor configured to control a wireless communication unit for communication between an electronic device and a social network server,
wherein the processor is configured to:
extract feature information from at least one of the inputs from the camera and the microphone, transmit the extracted feature information to a server, receive, from the server, at least one of information and a memo associated with an SNS user, who matches the extracted feature information, and display at least one of the received information and the received memo.

9. The SNS electronic device of claim 8, wherein the processor is configured to execute at least one of:
extracting facial feature information of a subject from the feature information input from the camera; and
converting a voice signal input from the microphone into text, and extracting feature information.

10. The SNS electronic device of claim 8, wherein the processor is configured to execute reception when a range of the information associated with the SNS user is set by the SNS user.

11. The SNS electronic device of claim 8, wherein the processor is configured to execute reception when a memo is input in association with the SNS user.

12. The SNS electronic device of claim 11, wherein, when the information indicating that the SNS user who matches the extracted feature exists is received from the server, the processor is configured to input a voice signal through the microphone so as to input a memo associated with the SNS user.

13. The SNS electronic device of claim 8, wherein the processor is configured to display at least one of the information and the memo, together with a subject input from the camera.

14. The SNS electronic device of claim 8, wherein the processor is configured to display at least one of the information and the memo, together with feature information of the SNS user.

15. A social network service method using an electronic device, the method comprising:
receiving feature information from an electronic device;
searching for a Social Network Service (SNS) user who matches the feature information; and
transmitting, to the electronic device, at least one of information and a memo associated with the SNS user.

16. The method of claim 15, wherein transmitting comprises:
executing transmission when a range of the information associated with the SNS user is set by the SNS user.

17. The method of claim 15, wherein transmitting comprises:
transmitting information indicating existence to the electronic device when it is determined that the SNS user who matches the feature information exists; and
executing transmission when a memo associated with the SNS user, of which information exists in the server, is received from the electronic device and is stored.

18. A Social Network Service (SNS) electronic device, comprising:
a data storage unit including a feature database (DB), the data storage unit configured to store feature information of an SNS user, a personal information DB that stores information associated with the SNS user, and a memo DB that stores a memo input to the SNS user; and
a processor configured to control a wireless communication unit for communication between an electronic device and a social network server,
wherein the processor is configured to:
receive feature information from an electronic device, search for an SNS user who matches the feature information, and transmit, to the electronic device, at least one of information and a memo associated with the SNS user.

19. The SNS electronic device of claim 18, wherein the processor is configured to execute transmission when a range of the information associated with the SNS user is set by the SNS user.

20. The SNS electronic device of claim 18, wherein the processor is configured to execute:
transmitting information indicating existence to the electronic device when it is determined that the SNS user who matches the feature information exists; and
executing transmission when a memo associated with the SNS user, of which information exists in the server, is received from the electronic device and is stored.
